(19) United States
(12) Patent Application Publication
(10) Pub. No.: US 2012/0261407 A1
(43) Pub. Date: Oct. 18, 2012

(54) Sea-land shipping comtainer slideout conversion system

(76) Inventors: Steven Cross, Chilliwack (CA); Lucas Griffin, Kelowna (CA); Mariusz Kaluski, Chilliwack (CA)

(21) Appl. No.: 13/066,410

(22) Filed: Apr. 15, 2011

(51) Int. Cl. B65D 88/12; B23P 23/00

(52) U.S. Cl. 220/1.5; 29/401.1

(57) ABSTRACT

A sea-land shipping container slideout conversion system, where the slideout unit generally has a floor, three walls and a roof. The slideout is mounted on a pair of vertically parallel slidable elevation members, which are slidably attached to two parallel horizontal sliding rails. The side of the container is cut out for the slideout and a ridged steel frame is welded into the cut-out. The slide rails slide in four spaced-apart roller box units that are mounted under the container between the container floor joists. The slideout unit is balanced and raised on the elevation members and slid inside of the container on the slidable rails. A plurality of seals are added to the slideout unit to seal the slideout unit to the container, both when the slideout unit is retracted and extended. When slid out of the container and lowered the slideout is locked in place outside of the container, so the floor of the slideout unit is level with the floor of the container and effectively sealed with the container.

### FIELD OF INVENTION

This invention relates generally to a sea-land shipping container having a slideout extension and more particularly, to the conversion of an intermodal sea-land shipping container so as to expand the container's size as may be required for use in a mobile office, or mobile living area, or a variety of other applications.

### BACKGROUND

Shipping containers having extensions and slide-out additions are generally well known, whereas the present invention offers unique properties and arrangements. The objects and advantages of the present invention will become clear to those skilled in the art in view of the Summary of the Invention and in the Detailed Description Of The Preferred Embodiments. Some of these advantages are listed below. The inventors are not aware of any adaptations or conversions that have these same advantages.

Past inventions that include slideout additions are numerous. Known art that the inventors are aware of include; U.S. Pat. No. 3,966,075 issued to Schultz on Jun. 29, 1976 entitled, Cargo container. U.S. Pat. No. 5,170,901 issued to Bersani on Dec. 15, 1992, entitled, Transportable construction element in the form of a container. U.S. Pat. No. 5,577,351 issued to Dewald, Jr., et al. on Nov. 26, 1996, entitled, Slide out room with flush floor. U.S. Pat. No. 6,494,334 issued to Cheng on Dec. 17, 2002, entitled, Structure of a container. U.S. Pat. No. 7,290,372 issued to Aust, et al. Nov. 6, 2007, entitled, Expandable container. U.S. Pat. No. 5,732,839 issued to Schimmang, et al. on Mar. 31, 1998, entitled, Container. U.S. Pat. No. 7,712,813 issued to Di Franco on May 11, 2010, entitled, Expandable trailer. U.S. Pat. No. 7,823,337 issued to Pope on Nov. 2, 2010, entitled, Deployable prefabricated structure with a nested extension structure; all of which are listed here for reference purpose only.

### SUMMARY OF THE INVENTION

The unique design of this sea-land shipping container slideout extension conversion allows the expanded size of an Intermodal Steel Building Unit (ISBU), also referred to as an ISO Sea-Land Shipping Container, so that the container can be used as an emergency shelter, a construction office or a transportable living space etc.

The conversion starts with a steel ISO (International Standardization Organization) shipping container of desired length, where a section of the side of the container is measured and outlined, onto the outside of the steel wall of the container where the slideout is desired to be inserted. This would normally be somewhere near the center area of the container and in line with the containers floor joists. The steel side is cut away from the container along the outline and down to and level with the container floor. This steel side is saved and can be used as the roof of the slideout.

A reinforced frame is build around the inside of container cutout wall and is welded in place within the outlined cutout and generally along the center of the edge of the steel container wall.

Next the lower beam of the exterior side of the container is marked and cut out in the shape of an I-beam as is used for the slideout roller rails. Two pairs of pre-constructed rail roller box units are welded in line with the I-beam cut out between the containers floor joists to accept the I-beam rails that are part of the slideout system.

A slideout unit is framed and fabricated to suit the container cutout, where the slideout unit is mounted onto the slideout rails by lowering the slideout onto a pair of vertical elevation guides, one on the end of each rail. The fabricated slideout framed unit is slid into the container cutout and the rails slide into the I-beam cutout and into the slide rail rollers. Once the slideout unit is inserted into the container cutout and into the slide rail roller boxes, an interior edge frame is attached to the slideout unit. The slideout edge frame prevents the slideout unit from coming out of the container when the slideout is extended and also acts to seal the container wall to the slideout unit when the slideout unit is extended. Weatherproof seals are added to seal the slideout unit both when extended and retracted.

When the slideout unit is completed and installed into the container cutout, there are two sets of alignment pins, where each set includes two top alignment pins and two bottom alignment pins. One set of pins are attached on either side of the slideout unit, where the alignment pins are matched to alignment pin saddles, where the saddles are attached to the container cutout reinforcement frame and to the lower corner container beam, one on each bottom and one on each top area. When the slideout unit is extended and then lowered, the alignment pins settle into the saddles to hold the slideout unit firmly in place with the seals in contact with the container cutout frame and the slideout reinforcement frame.

The lift and slide of the container slideout conversion allows the addition of insulation value up to of R24 in the floor of the unit. The slide is made from steel to provide structural integrity as well as withstand any snow load, debris from wind such as trees etc, which may sit on the roof. The slideout unit and the container can also be finished with siding on the exterior and finish on the interior as may be desired.

A principal object of the invention is to provide a slideout conversion system for a standard sea-land shipping container.

Another object of the invention is to provide a slideout conversion system for a standard sea-land shipping container that can be operated manually or automatically.

Another object of the present invention is to provide an improved method of a slideout conversion system for a standard sea-land shipping container that is more compact in size and easier to transport.

A further object is to provide a slideout conversion system for a standard sea-land shipping container that allows the insulating of the floor to a high R-value of up to an R24 insulation rating as the slideout is designed to slide out, drop down, and become level with existing container floor.

Yet a further object is to provide a slideout conversion system for a standard sea-land shipping container that is cost effective and suitable for the recreation vehicle marketplace.

The present invention has other objects and features of advantage, which will become apparent from and are set forth in more detail in the description and the accompanying drawings.

### BRIEF DESCRIPTION OF DRAWINGS

Advantages of the present invention will become more fully appreciated as the same becomes better understood when considered in conjunction with the following detailed description of an illustrative embodiment and accompanying drawings, in which like reference characters designate the same or similar parts throughout the several views, wherein;

FIG. 1 is a front perspective view of a sea-land shipping container slideout conversion system, according to the embodiment of the present invention.

FIG. 2 is a rear perspective view of a sea-land shipping container slideout conversion system, according to the embodiment of the present invention.

FIG. 3 is a sectional perspective view of a vertical elevation slide and a horizontal rail slide, according to the embodiment of the present invention.

FIG. 4 is a sectional perspective view showing a vertical elevation, according to the embodiment of the present invention, showing the slideout unit in the up position for retraction, as being raised by a bottle jack.

FIG. 5 is a sectional perspective view showing a vertical elevation, according to the embodiment of the present invention, showing the slideout unit in the down position for extension, as being lowered by a bottle jack.

FIG. 6 is a sectional front elevational view of the slideout unit and rails, showing the slideout unit raised as would be when retracted into a container (not shown), according to the embodiment of the present invention.

FIG. 7 is a sectional front elevational view of the slideout unit and rails, showing the slideout unit lowered as would be when extended out from a container (not shown), according to the embodiment of the present invention.

FIG. 8 is a front elevational view of the container cutout reinforcement frame, according to the embodiment of the present invention.

FIG. 9 is a front elevational view of the container cutout reinforcement frame installed on a sectional view of a container side, according to the embodiment of the present invention.

FIG. 10 is a side elevational view of the rail and elevation member, including the roller box units, showing a sectional side view of a container taken along line A of FIG. 9, according to the embodiment of the present invention.

FIG. 11 is a sectional perspective view of a roller box unit, according to the embodiment of the present invention.

FIG. 12 is a side elevational view of a roller box unit installed between a container's floor joists, according to the embodiment of the present invention.

FIG. 13 is a side elevational view of a roller box unit installed between a containers floor joists and behind container lower side beam showing the I-beam slot in the container lower beam, according to the embodiment of the present invention.

FIG. 14 is a sectional side elevational view showing a lower alignment pin in the up position and above the saddle latch, also seen is the lower weather seals between the container and the slideout unit, according to the embodiment of the present invention.

FIG. 15 is a sectional side elevational view showing a lower alignment pin in the down position and in the saddle latch, also seen is the lower weather seals in contact between the container and the slideout unit, according to the embodiment of the present invention.

FIG. 16 is a sectional side elevational view showing a top alignment pin in the up position and above the saddle latch, also seen is the top weather seals in contact between the container and the slideout unit according to the embodiment of the present invention.

FIG. 17 is a sectional side elevational view showing a top alignment pin in the down position and in the saddle latch, also seen is the top weather seals in contact between the container and the slideout unit according to the embodiment of the present invention.

FIG. 18 is a sectional side elevational view showing the top weather seals between the container and the slideout unit, according to the embodiment of the present invention.

FIG. 19 is a sectional plan view showing the side weather seals between the container and the slideout unit, according to the embodiment of the present invention.

### DETAILED DESCRIPTION OF THE PREFERRED EMBODIMENTS

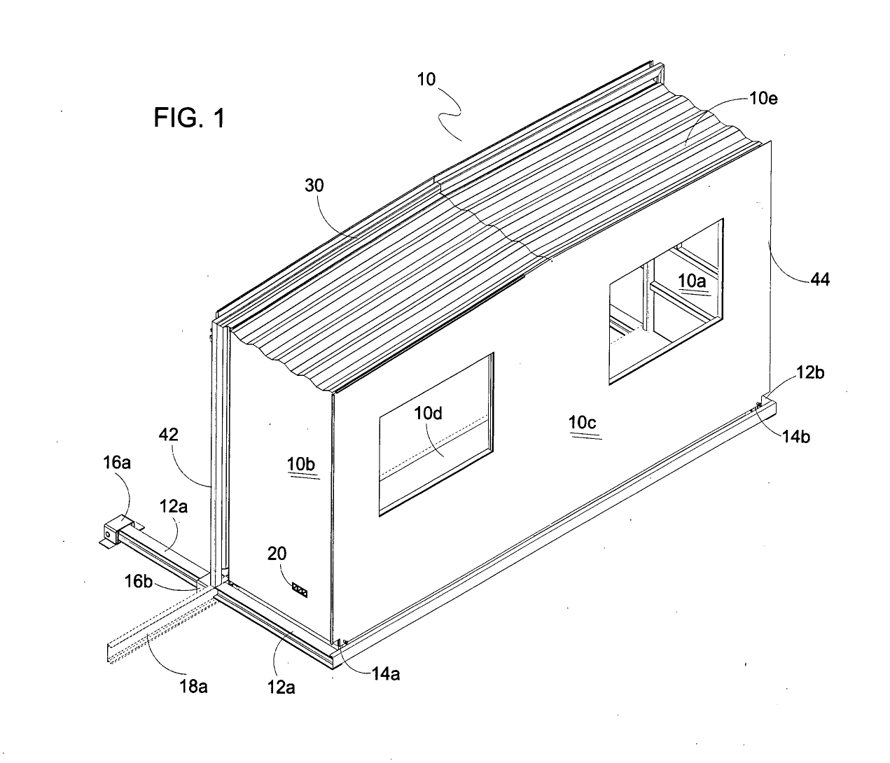

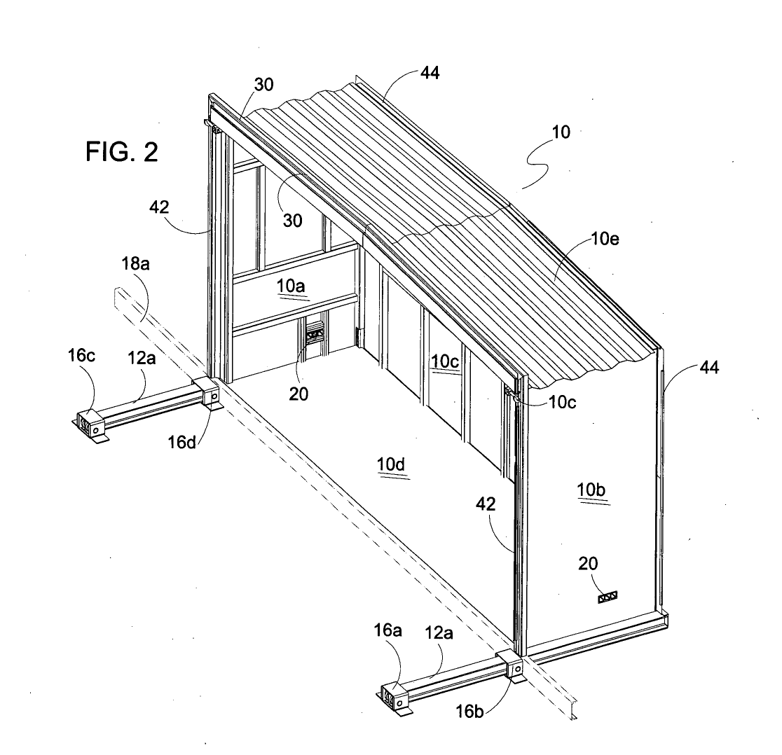

Referring generally to FIGS. 1 and 2 where perspective views show the sea-land shipping container slideout conversion system, where the slideout is generally referred to here as slideout unit 10. Slideout unit 10 includes a first side wall 10a, a second side wall 10b, a third outer wall 10c, a floor 10d and a roof 10e. Two parallel horizontal slidable rails, rail 12a and rail 12b are attached to slideout unit 10 by parallel vertical elevation members 14a and 14b. Four roller box units 16a, 16b, 16c and 16d are spaced-apart and affixed under container 18 to accept rail 12a and rail 12b. Container 18 has a lower corner beam 18a, which has rail cut outs 18b and 18c (see FIGS. 9 and 13) so that rails 12a and 12b can slide through beam 18a and into roller box units 16a, 16b, 16c and 16d, which are adapted to slidably accept rails 12a and 12b.

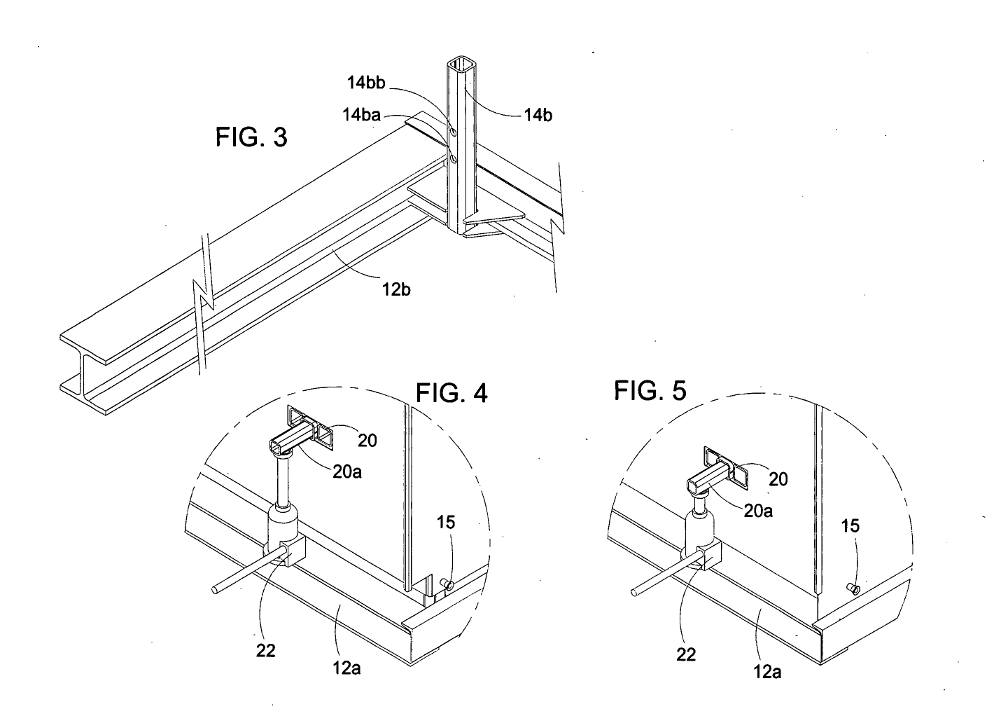

Referring generally to FIGS. 3 through 7, with FIG. 3 best showing elevation member 14b attached to rail 12b, where rail 12b is shown in section view. Slideout 10 includes a horizontally adjustable lift opening 20, where a lift-pin 20a is shown selectively inserted into lift opening 20. A hydraulic jack 22 is shown positioned under a lift-pin 20a, where hydraulic jack 22 is used to raise and lower slideout unit 10. Slideout unit 10 may be heavier in areas where furniture or material is placed within slideout unit 10, so lift pin 20a may be adjusted horizontally within lift opening 20 to balance slideout unit 10 when raising and lowering slideout unit 10.

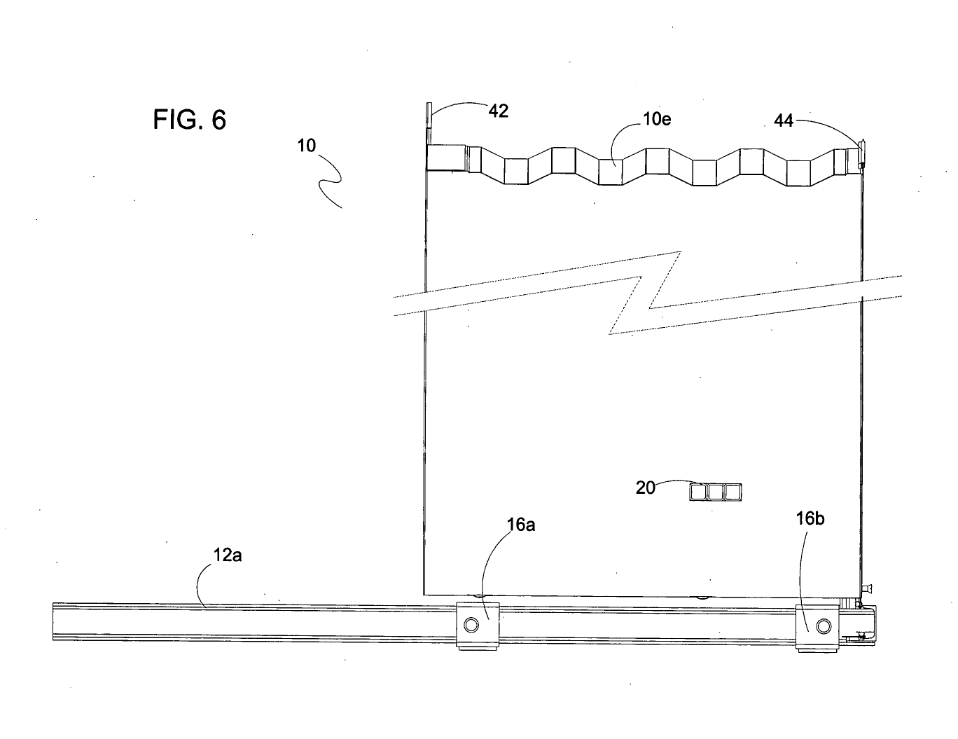

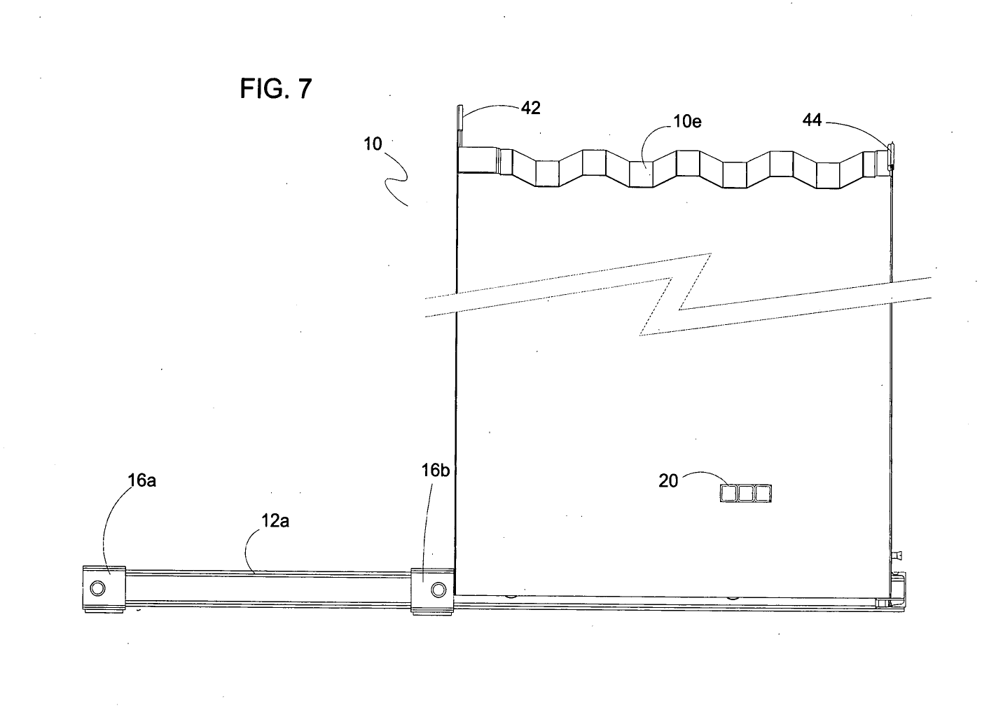

FIG. 4 and FIG. 6 show slideout unit 10 in the up position when raised for sliding slideout unit 10 in or out. Elevation members 14a and 14b include an elevation member holes 14aa and 14ba (as seen in FIG. 3). A pair of elevation lock pins 15 are inserted into elevation member holes 14aa or 14ba to hold slideout unit 10 in the up position as slideout unit 10 is slid into container 18 and in the down position as slideout unit 10 is slid out of container 18 and lowered to level slideout unit floor 10d and container floor 18d. FIG. 5 and FIG. 7 show slideout unit 10 in the down position as when slideout unit 10 is lowered after extension of slideout unit 10.

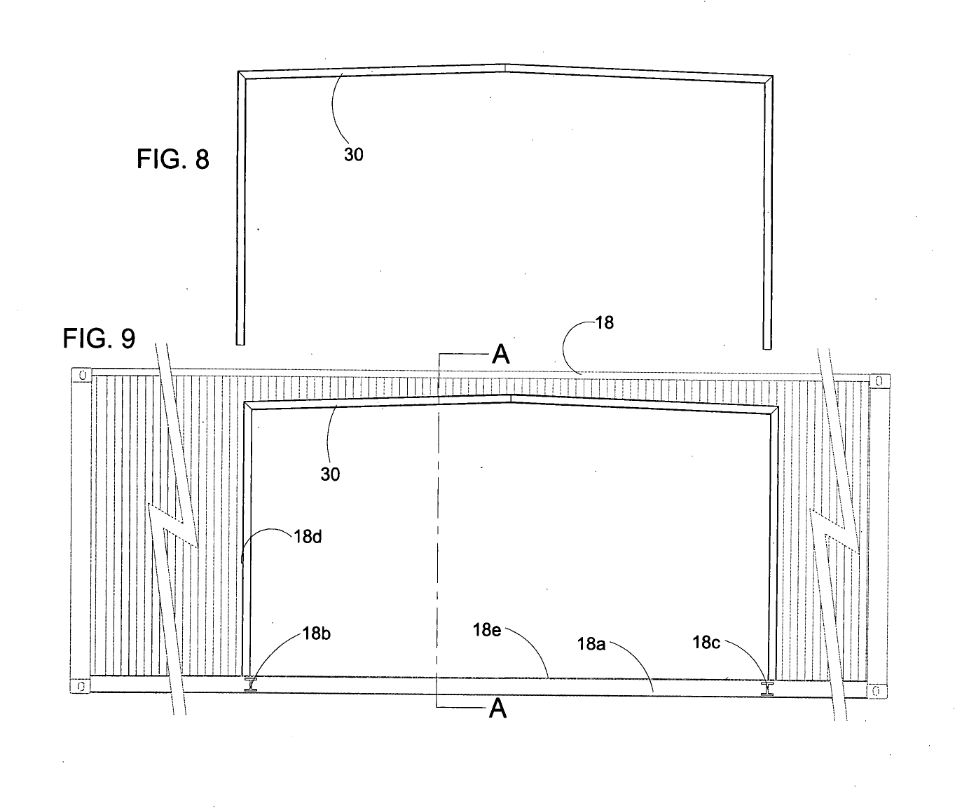

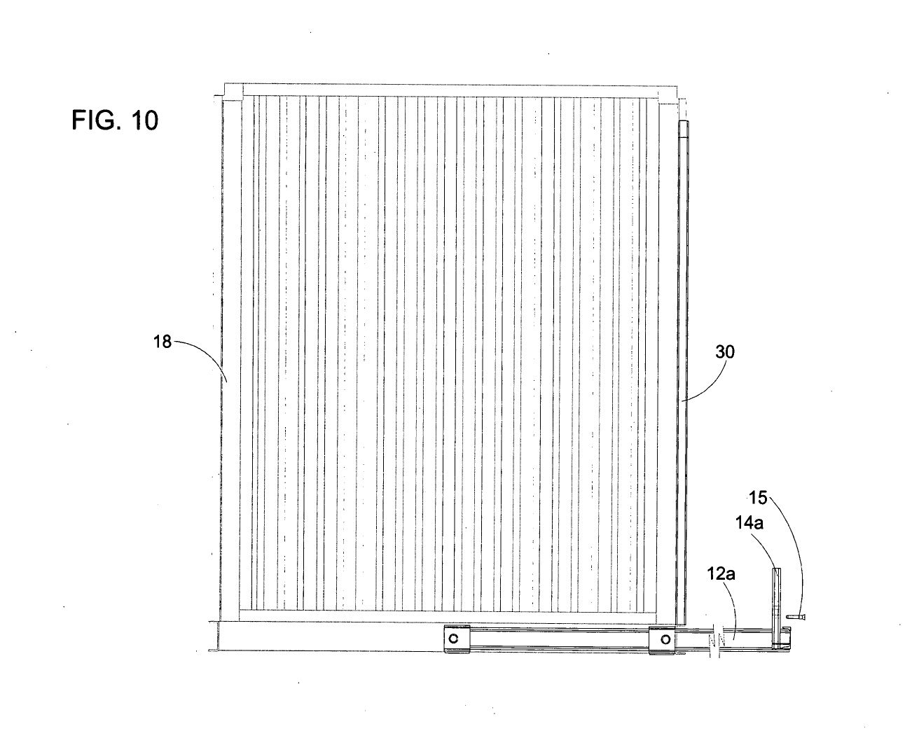

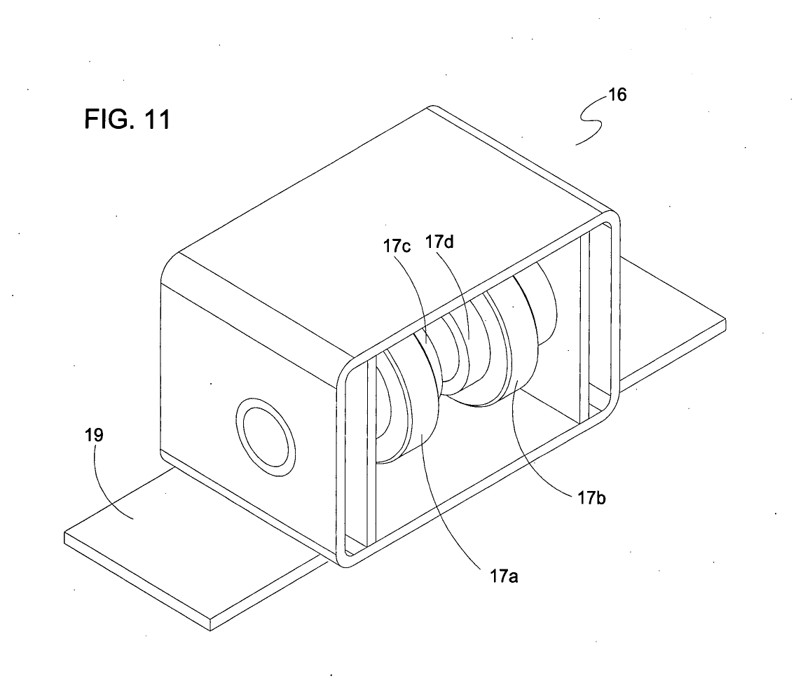

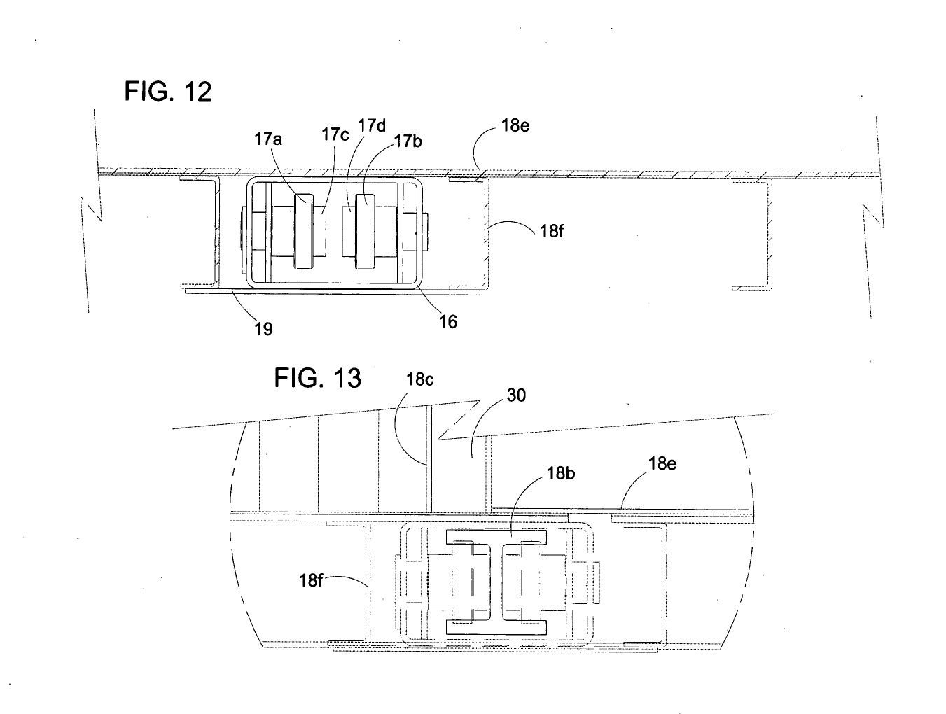

Referring generally to FIGS. 8, 9 and 10, container 18 is cut out to accept slideout unit 10, where cutout 18d accepts a frame 30, frame 30 is fixed to container cutout 18e normally by welding. Slideout unit 10 contacts frame 30 when retracted into container 18 and slideout unit 10 contacts frame 30 when extended out of container 18. As best seen in FIG. 11, roller box units 16 include roller bearings 17a, 17b, and thrust bearings 17c and 17d. Roller box units 16 also include plate 19, where plate 19 allows easy and adjustable fixing of roller box 16 to container floor joists 18f as best seen in FIG. 12 and FIG. 13. Container slide rail slot cut-outs 18b and 18c are cut through container beam 18a to accept slide rails 12a and 12b below container floor 18e.

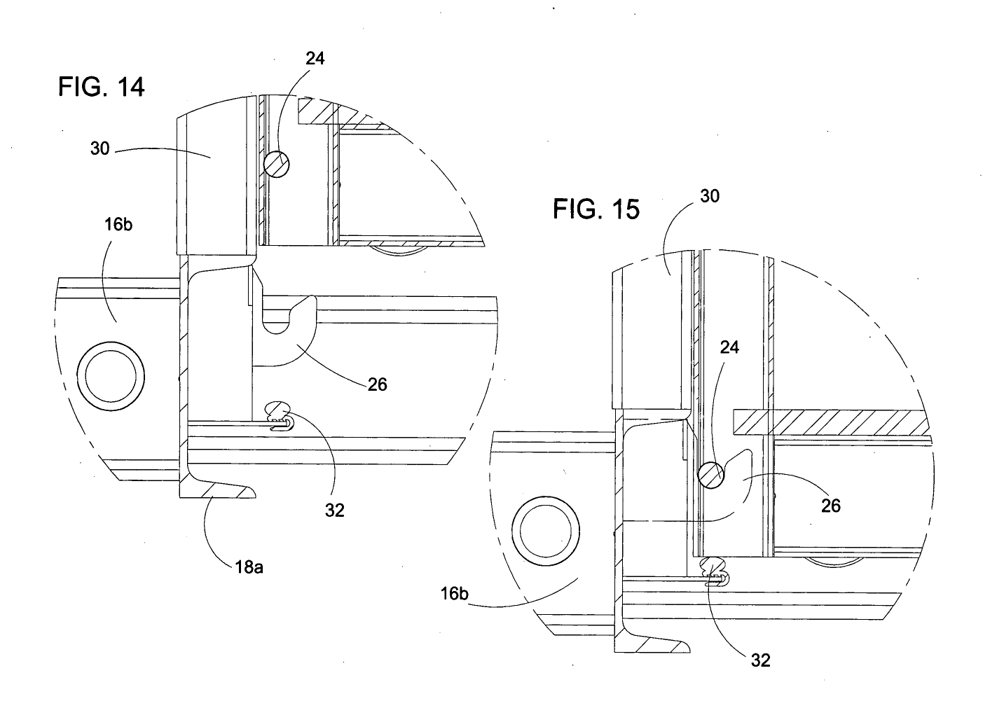

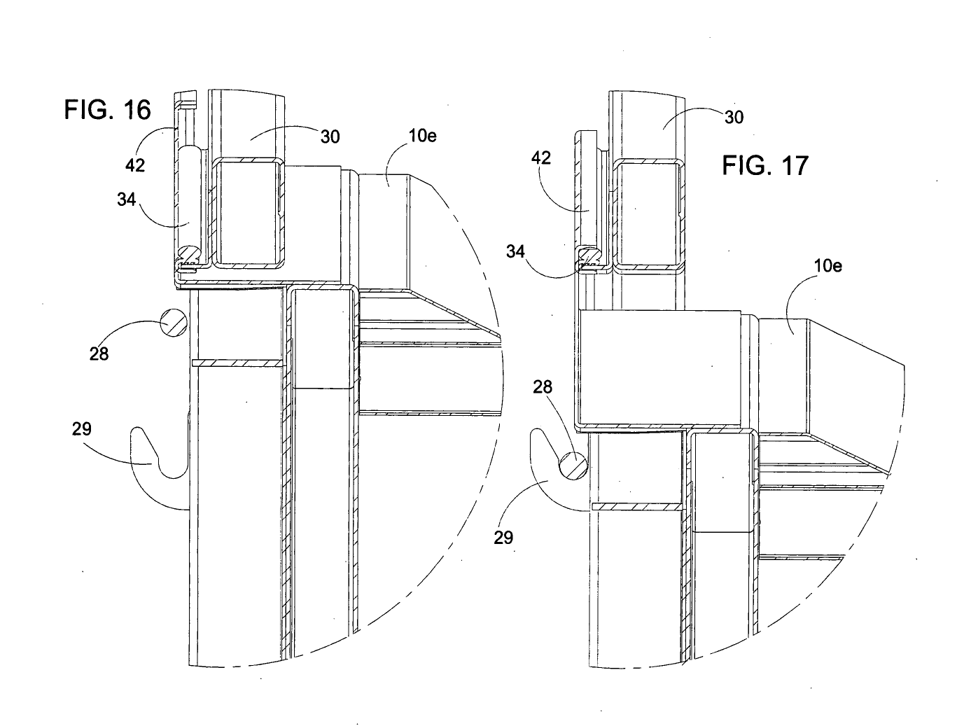

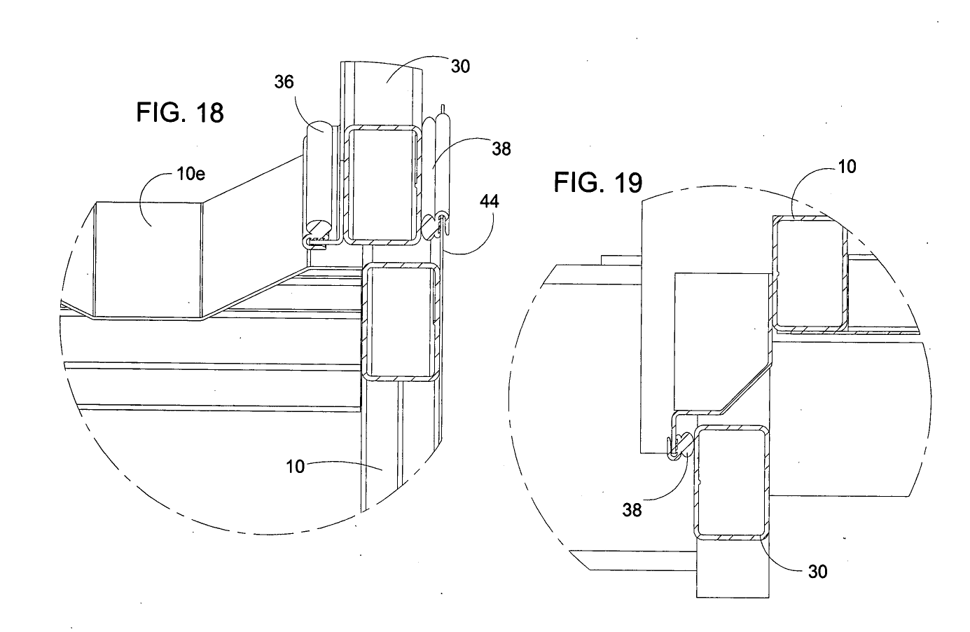

Referring generally to FIGS. 14 through 19, with FIGS. 14 and 15 best showing lower slideout alignment pin 24, which locks into lower saddle 26 when slideout unit 10 is lowered. FIGS. 16 and 17 best showing upper slideout alignment pin 28, which lock into upper saddle 29 when slideout unit 10 is lowered. Again referring generally to FIGS. 14 through 19, weatherproof seals 32, 34, 36 and 38 can be seen in contact with slideout unit 10, having an inner slideout flange 42 and outer slideout flange 44.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. While the invention has been described in its preferred embodiments, it is to be understood that the words which have been used are words of description and not of limitation. Therefore, changes may be made within the appended claims without departing from the true scope of the invention.

It is intended that the scope of the invention be defined by the Claims appended hereto and their equivalents, which should be given their fair and fullest scope.

What is claimed is:

1. A sea-land shipping container slideout conversion system, comprising: a slideout unit having a first side wall, a second side wall, a third outer wall, a floor and a roof, where said first side wall, said second side wall, said third outer wall, said floor and said roof are arranged adjacent to one another and are rigidly connected to one another to form said slideout unit; said container has a cutout outline to accept said slideout unit, where said container cutout outline is strengthened by an outline frame, said outline frame being affixed to said container cutout; said slideout unit is mounted on and vertically slidably connected to at least two parallel vertical elevation members, said vertical elevation members are slidably attached to at least two parallel horizontal slidable rails, said slidable rails attached to said elevation members so as to reside thereunder said slideout unit; spaced-apart and affixed thereunder said container are at least four roller box units, said roller box units adapted to slidably accept said slidable rails; and
where said slideout unit is adapted to be selectively lifted on said elevation members and slid inside of said container through said outline frame, on said slidable rails and selectively slid out of said container on said slidable rails and selectively lowered outside of said container on said elevation members, so as to level said floor of said slideout with a floor inside of said container.

2. The system as defined in claim 1, where said outline frame contacts weather seals attached to said slideout unit when said slideout unit is retracted within said container.

3. The system as defined in claim 1, where said outline frame contacts weather seals attached to said slideout unit when said slideout unit is extended and lowered outside of said container.

4. The system as defined in claim 1, where elevation of said slideout unit is controlled manually.

5. The system as defined in claim 1, where elevation of said slideout unit is controlled automatically.

6. The system as defined in claim 1 where said slideout unit locks into at least two saddles when said slideout unit is extended out and lowered outside of said container.

7. The system as defined in claim 1, where said roller box units are designed to be adjustably aligned between container joists when affixed under said container.

8. A conversion method for adapting a slideout unit to a steel sea-land shipping container, the method comprising:
a) aligning and cutting an opening through a side of said container, said opening correspondingly aligned with container floor joists;
b) reinforcing said opening in said container with an opening frame;
c) cutting at least two rail slots into a lower side beam of said container, said slide rail slots correspondingly aligned with said container floor joists;
d) aligning and affixing a pair of roller box units between said container floor joists thereunder said container, opposed to and correspondingly aligned to each said slide rail slot;
e) connecting said slideout unit onto at least two vertical elevation members;
f) affixing said elevation members unit onto at least two horizontal slide rails;
g) inserting said slide rails into said slide rail slots;
h) sliding said slideout unit into said roller boxes and through said container opening frame;
i) affixing an inner flange around said slideout;
j) affixing weather seals to said inner flange on said slideout;
k) affixing weather seals to an outer flange on said slideout;
l) affixing at least two saddles to said opening frame;
m) affixing at least two alignment pins to said slideout unit, so that said alignment pins coinciding with said saddles.

9. The method as defined in claim 8, where said slideout is selectively extended and lowered so said alignment pins come into contact with said saddles and said seals come into contact with said slideout inner flange.

10. The method as defined in claim 8, where a slideout floor becomes level with a floor inside of said container when said slideout is extended.

11. The method as defined in claim 8, where said slideout is selectively lifted and retracted so said seals come into contact with said slideout outer flange.

12. The method as defined in claim 8, where said slideout is locked when retracted by a set of fasteners.

13. The method as defined in claim 8, where there are four roller boxes.

14. The method as defined in claim 8, where there are four said saddles and four said alignment pins.
